(19) United States
(12) Patent Application Publication
(10) Pub. No.: US 2010/0193728 A1
(43) Pub. Date: Aug. 5, 2010

(54) Chemical Mechanical Polishing Composition

(76) Inventors: Song-Yuan CHANG, Zhongli City (TW); Ming-hui Lu, Zhongli City (TW); Ming-Che Ho, Zhongli City (TW)

Correspondence Address: Jackson Intellectual Property Group PLLC, 106 Starvale Lane, Shipman, VA, 22971, US

(21) Appl. No.: 12/186,302

(22) Filed: Aug. 5, 2008

(51) Int. Cl. C09K 13/00

(52) U.S. Cl. 252/79.1

(57) ABSTRACT

An inhibitor composition according to the present invention at least comprises an imidazoline compound or a triazole compound or combinations thereof, and sarcosine and salt compounds thereof or combinations thereof. The inhibitor composition is applicable to chemical mechanical polishing so as to maintain a high removal rate of metal layers as well as suppress metal etching, thereby reducing polishing defects such as dishing, erosion and the like.

### BACKGROUND OF THE INVENTION

(a) Field of the Invention

The present invention relates to an inhibitor composition used for chemical mechanical polishing, and its object is to provide an inhibitor composition used in chemical mechanical polishing compositions, thereby improving the planarization effect of a work piece.

(b) Description of the Prior Art

With the critical dimension of an electronic component becoming more and more compact and the wiring layer number thereof rapidly increasing, the RC time delay significantly affects the operation speed of the entire circuits. In order to improve the problems of the time delay and the reliability of electron migration due to the reduction in metal line width, copper conductor material with low resistivity and high resistance to damage by electron migration is selected to replace aluminum alloys. However, it needs to employ another damascene process in forming copper conductors because copper metal is difficult to be etched.

Damascene processes are different from traditional metallization processes, in which metallic patterns are initially defined, followed by filling trenches with dielectric layers. In the damascene process, a conductive line trench is first etched in a flat dielectric layer, filling a metal layer therein, and finally removing excess metal to obtain a flat structure with metal inlayed in the dielectric layer. Damascene processes have the following advantages in comparison with traditional metallization processes: (1) the surface of a substrate is always kept flat; (2) the drawback that dielectric material is difficult to be filled into the spacing between metallic conductors in traditional processes can be eliminated; (3) the difficulty in etching metallic material, especially etching copper metal could be solved.

Moreover, in order to overcome the drawback that the necessity of separately fabricating a contact window structure and a conductor pattern makes the fabrication procedures of a traditional interconnection process extremely complicated, currently, a dual damascene process is further developed. In the dual damascene process, a line dielectric and a via dielectric are respectively etched off by two times of selective etching, completing the barrier layers of the metal layer and of the plug at a time, then filling conductive metal into the vias and interconnection trenches at a time, so as to simplify the fabrication procedures. In recent years, copper metal with low resistivity and high resistance to electron migration has been gradually used as the material of metal interconnects instead of aluminum metal in the prior process technology to meet the requirement for miniaturizing the components and increasing the operation speed thereof. Copper damascene interconnection technology not only can achieve the miniaturization of interconnects and the reduction of RC time delay, but also can solve the difficulty in etching metallic copper. Therefore, it has become the main trend of the development of multiple interconnections today.

Regardless of in a single damascene or in a dual damascene copper process, after the completion of the copper metal filling, it needs to perform a planarization process for removing excess metal on the dielectric layer. Currently, this purpose is usually achieved by a chemical mechanical polishing process. However, in metal chemical mechanical polishing, polishing defects such as metal dishing, erosion and the like still often occur on the surface of a metal layer.

Metal dishing and erosion are strongly associated with the removal rate and RR/DER ratio. A lower removal rate can ensure a low removal rate on a pattern recess to effectively suppress dishing defects, but in view of the throughput of the unit, the removal rate must be maintained within an acceptable range. Furthermore, the polishing uniformity affects the planarity to a certain extent. More polishing time is required for completely removing copper with poorer uniformity, thus causing more serious metal dishing and erosion problems.

To give consideration to both the throughput of the unit and the suppression of metal dishing and erosion, a copper chemical mechanical polishing process is often divided into two stages. In the first stage, most copper is removed at a higher removal rate to increase the throughput of the unit. In the second stage, a small amount of the remaining copper is polished off at a lower removal rate to prevent the copper in the trenches from excessive erosion. In general, a two-stage copper polishing process needs to change polishing compositions of different formulations to satisfy the requirements in the various stages for polishing copper. However, changing polishing compositions is disadvantageous to process simplification as well as increases the waste.

U.S. Pat. No. 6,679,929 disclosed a polishing composition comprising at least one abrasive, an aliphatic carboxylic acid having at least 10 carbon atoms, a basic compound, a polishing accelerating compound, an anticorrosive, hydrogen peroxide and water. Although the polishing composition can reduce the etching rate of copper metal, it also adversely affects the removal rate of bulk copper. In addition, US Patent Publication No. 2004/0020135 disclosed a copper polishing composition comprising silica, an oxidant, amino acid, a triazole compound and water, but it did not disclose that a polishing composition employing a co-inhibitor could decelerate the metal etching rate under the condition of maintaining a high removal rate and meanwhile was suited to the first and second stages for polishing copper metal.

### SUMMARY OF THE INVENTION

A primary objective of the present invention is to provide an inhibitor composition used for chemical mechanical polishing, thereby suppressing the etching rate of a work piece.

Another objective of the present invention is also to provide a chemical mechanical polishing composition suitable for two-stage metal polishing.

To achieve the above objectives, an inhibitor composition according to the present invention at least comprises: an imidazoline compound or a triazole compound or combinations thereof, and sarcosine and salt compounds thereof or combinations thereof, wherein the imidazoline compound or triazole compound or combinations thereof can be 1H-benzotriazole, and the sarcosine and salt compounds thereof can be N-acyl sarcosine. The inhibitor composition is used in chemical mechanical polishing so compositions, which can form a protective film on the surface of a work piece so as to maintain a high removal rate of metal layers as well as effectively suppress metal etching in chemical mechanical polishing, thereby reducing polishing defects such as dishing, erosion and the like.

### DETAILED DESCRIPTION OF THE PREFERRED EMBODIMENTS

### Brief Description of the Drawings

The present invention provides a chemical mechanical polishing composition, and the inhibitor composition at least comprises an imidazoline compound or a triazole compound or combinations thereof, and sarcosine and salt compounds thereof or combinations thereof. The inhibitor composition is used in chemical mechanical polishing compositions, which can form a protective film on the surface of a work piece to prevent the work piece from corrosion in chemical mechanical polishing and can enhance the anticorrosion ability of the work piece. The chemical mechanical polishing composition further comprises abrasive particles, an oxidant, an accelerator and a solvent.

Examples of the abrasive particle include, but not limited to, calcined silica; silica sols hydrolyzed from sodium silicate or potassium silicate, or hydrolyzed and condensed from silane; precipitated or calcined alumina; precipitated or calcined titania; polymeric materials; and hybrids of metal oxides and polymeric materials, and preferably silica sols. When the amount of the abrasive particles is too small, it is disadvantageous to mechanical polishing and the desired removal rate cannot be achieved. On the other hand, too much amount of abrasive particles would accelerate the effect of mechanical polishing and increase the removal rate of barrier layers and insulation oxide layers, thus easy to cause polishing defects such as erosion on the surface. In one embodiment, the silica sol is used in an amount of 0.01 to 30% by weight based on the total weight of the composition, preferably 0.1 to 15% by weight.

In view of a chemical mechanical polishing composition for polishing copper layers, it is preferable to use hydrogen peroxide as an oxidant. In general, the oxidant is used in an amount of 0.25 to 5% by weight based on the total weight of the composition, preferably 0.5 to 3% by weight.

Examples of the accelerator used in the chemical mechanical polishing composition include, but not limited to, citric acid, oxalic acid, tartaric acid, histidine, alanine or glycine. The accelerator is used to promote the dissolution of metal to be polished, such as copper. When the added amount of the accelerator in the chemical mechanical polishing composition increases, it facilitates to increase the removal rate of metal layers and is suitable for the metal layer polishing in the first stage. However, the increased added amount of the accelerator in the polishing composition also increases the static etching rate and is unfavorable to the fine polishing in the second stage. In one embodiment, the accelerator is used in an amount of 0.01 to 10% by weight based on the total weight of the composition, preferably 0.1 to 5% by weight, and more preferably 0.3 to 3% by weight.

The inhibitor composition effectively suppresses the static etching rate under the condition of high removal rates, so as to suit the polishing processes both in the first and second stages. According to the present invention, the imidazoline compound or triazole compound or combinations thereof can be 1H-benzotriazole (BTA), which represent from 0.001 to 1% by weight, preferably from 0.005 to 0.8% by weight, and more preferably from 0.01 to 0.5% by weight of the total weight of the composition, and the sarcosine and salt compounds thereof or combinations thereof represent from 0.0005 to 1% by weight, preferably from 0.001 to 0.5% by weight, and more preferably from 0.005 to 0.1% by weight of the total weight of the composition.

Examples of the sarcosine and salts thereof include, but not limited to, sarcosine

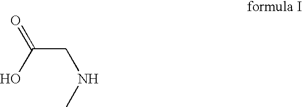

(CH₃NHCH₂COOH, CAS=107-97-1),
   lauroyl sarcosine

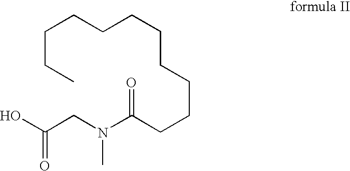

(C₁₅H₂₉NO₃, Cas 97-78-9),

N-acyl sarcosine, cocoyl sarcosine, oleoyl sarcosine, stearoyl sarcosine and myristoyl sarcosine or lithium salts, sodium salts, potassium salts, amine salts thereof, or the like, or mixtures thereof; for example, sodium n-Lauroyl sarcosinate:

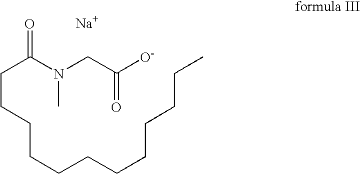

(CH₃ (CH₂)₁₀CON(CH₃)CH₂COONa, CAS 137-16-6),
   or sodium cocoyl sarcosinate:

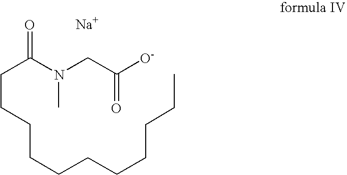

(RCON(CH₃)CH₂COONa, CAS 61791-59-1).

Water can be used as the solvent of the composition according to the present invention, and deionized water is preferably used as the solvent of said polishing composition.

The features and functions of the present invention are further illustrated by the following particular examples, but they are not to be construed to limit the scope of the present invention.

### Example 1

As listed in Table 1, the tests are conducted with polishing slurry compositions using silica sol as the abrasive particles, alanine, hydrogen peroxide, 1H-benzotriazole, sodium cocoyl sarcosinate and water as the solvent, as control samples.

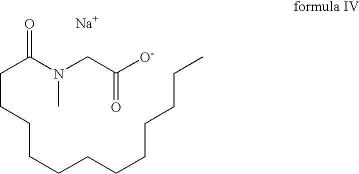

(RCON(CH₃)CH₂COONa, CAS 61791-59-1)

TABLE 1

| | oxidant | | | abrasive | sodium |
|---|---|---|---|---|---|
| | (hydrogen | accelerator | 1H-benzo- | particle | cocoyl |
| | peroxide) | (glycine) | triazole | (silica sol) | sarcosinate |
| | (wt %) | (wt %) | (ppm) | (wt %) | (ppm) |
| control | 0.8 | 0.8 | 50 | 0.1 | 0 |
| example 1 | | | | | |
| control | 0.8 | 0.8 | 0 | 0.1 | 60 |
| example 2 | | | | | |
| control | 0.8 | 0.8 | 25 | 0.1 | 60 |
| example 3 | | | | | |

The polishing tests are conducted under the following condition.

polisher: Mirra polisher (Applied Materials)
wafer type: 8-inch copper-coated wafer (Ramco Co)
polishing pressure: 1.5 psig and 0 psig
platen speed: 93 rpm
carrier speed: 87 rpm
polishing pad: IC 1010 (Rohm Inc.)
slurry flow rate: 150 ml/min

The removal rate on the wafer is measured using 4-point probe measurement. The results are shown in Table 2.

TABLE 2

| | RR@1.5 psig | WIWNU | DER@0 psig | |
|---|---|---|---|---|
| | (A/min) | (%) | (A/min) | RR/DER |
| control | 3349 | 5.1 | 1058 | 3.2 |
| example 1 | | | | |
| control | 4747 | 10.4 | 230 | 20.6 |
| example 2 | | | | |
| control | 5030 | 3.1 | 262 | 19.2 |
| example 3 | | | | |

Wherein RR refers to the removal rate, and WIWNU refers to the with-in-wafer-non-uniformity, and DER refers to the dynamic etching rate.

From the results in Table 2, it can be seen that control example 1 exhibits a low removal rate and a high etching rate, but the RR/DER ratio is low; control example 2 shows a higher RR/DER ratio, but the with-in-wafer-non-uniformity is poor. As known from the results, if the inhibitor composition according to the present invention is used (control example 3), the high removal rate for polishing copper can be kept, and the etching rate of copper can also be effectively reduced, thus increasing the RR/DER ratio.

### Example 2

As listed in Table 3, the tests are conducted with polishing slurry compositions using silica sol as the abrasive particles, alanine, hydrogen peroxide, 1H-benzotriazole, sodium cocoyl sarcosinate and water as the solvent, as control samples.

TABLE 3

| | oxidant | | | abrasive | sodium |
|---|---|---|---|---|---|
| | (hydrogen | accelerator | 1H-benzo- | particle | cocoyl |
| | peroxide) | (glycine) | triazole | (silica sol) | sarcosinate |
| | (wt %) | (wt %) | (ppm) | (wt %) | (ppm) |
| control | 0.8 | 0.8 | 0 | 0.2 | 58 |
| example 4 | | | | | |
| control | 0.8 | 0.8 | 15 | 0.2 | 58 |
| example 5 | | | | | |
| control | 0.8 | 0.8 | 20 | 0.2 | 58 |
| example 6 | | | | | |
| control | 0.8 | 0.8 | 25 | 0.2 | 58 |
| example 7 | | | | | |
| control | 0.8 | 1.2 | 30 | 0.2 | 58 |
| example 8 | | | | | |

The polishing tests are conducted under the following condition. The results are recorded in Table 4.

polisher: Mirra polisher (Applied Materials)
polishing pressure: 3 psig, 1.5 psig and 0 psig
platen speed: 93 rpm
carrier speed: 87 rpm
polishing pad IC: 1010 (Rohm Inc.)
slurry flow rate: 150 ml/min

TABLE 4

| | RR @3 psig | RR @1.5 psig | DER | |
|---|---|---|---|---|
| | (A/min) | (A/min) | (A/min) | RR/DER |
| control | 9618 | 5005 | 235 | 38.02 |
| example 4 | | | | |
| control | 6234 | 3220 | 116 | 53.74 |
| example 5 | | | | |
| control | 6490 | 3494 | 66 | 98.33 |
| example 6 | | | | |
| control | 5350 | 2560 | 80 | 66.88 |
| example 7 | | | | |
| control | 5859 | 3708 | 81 | 72.33 |
| example 8 | | | | |

It is clear from the results in Table 4 that the removal rate goes down with the increase in the concentration of 1H-benzotriazole under a constant concentration of sarcosine, so a preferred composition (control example 6) can be obtained, which has a high copper removal rate, a low etching rate, and a higher RR/DER ratio.

The technical contents and features of the present invention are disclosed above. However, anyone familiar with the technique could possibly make modify or change the details in accordance with the present invention without departing from the spirit of the invention. The protection scope of the present invention shall not be limited to what embodiment discloses, and should include various modification and changes that are made without departing from the spirit of the present invention, and should be covered by the claims mentioned below.

I claim:

1. An inhibitor composition used for chemical mechanical polishing at least comprising:
an imidazoline compound or a triazole compound or combinations thereof; and
sarcosine and salt compounds thereof or combinations thereof.

2. The inhibitor composition used for chemical mechanical polishing as claimed in claim 1, wherein the sarcosine and salt compounds thereof include sarcosine, N-acyl sarcosine, lauroyl sarcosine, cocoyl sarcosine, oleoyl sarcosine, stearoyl sarcosine and myristoyl sarcosine or lithium salts, sodium salts, potassium salts or amine salts thereof or combinations thereof.

3. The inhibitor composition used for chemical mechanical polishing as claimed in claim 1, wherein one of the sarcosine and salt compounds thereof is sarcosine, the chemical formula of sarcosine is represented by formula I: 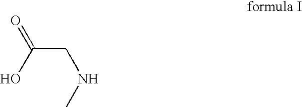
(CH₃NHCH₂COOH, CAS=107-97-1).

4. The inhibitor composition used for chemical mechanical polishing as claimed in claim 1, wherein one of the sarcosine and salt compounds thereof is lauroyl sarcosine, the chemical formula of lauroyl sarcosine is represented by formula II: 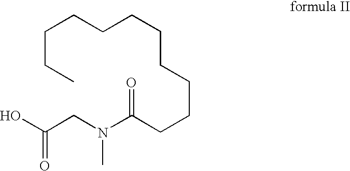
(C₁₅H₂₉NO₃, CAS 97-78-9).

5. The inhibitor composition used for chemical mechanical polishing as claimed in claim 1, wherein one of the sarcosine and salt compounds thereof is sodium lauroyl sarcosinate, the chemical formula of sodium lauroyl sarcosinate is represented by formula III: 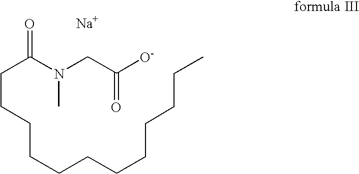
(CH₃ (CH₂)₁₀CON(CH₃)CH₂COONa, CAS 137-16-6).

6. The inhibitor composition used for chemical mechanical polishing as claimed in claim 1, wherein one of the sarcosine and salt compounds thereof is sodium cocoyl sarcosinate, the chemical formula of sodium cocoyl sarcosinate is represented by formula IV:

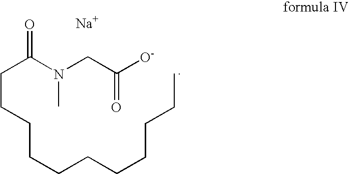

7. The inhibitor composition used for chemical mechanical polishing as claimed in claim 1, wherein the triazole compound is selected from the group consisting of 1,2,4-triazole, 3-amino-1,2,4-triazole, 3-nitro-1,2,4-triazole, 3-amino-1H-1,2,4-triazole-5-carboxylic acid, 1H-benzotriazole and 5-methyl-1,2,3-benzotriazole.

8. The inhibitor composition used for chemical mechanical polishing as claimed in claim 1, wherein the triazole compound is 1H-benzotriazole.

9. The inhibitor composition used for chemical mechanical polishing as claimed in claim 1, wherein the chemical mechanical polishing composition further comprises abrasive particles, an oxidant, an accelerator and a solvent.

10. The inhibitor composition used for chemical mechanical polishing as claimed in claim 9, wherein the abrasive particle is selected from the group consisting of calcined silica; silica sols hydrolyzed from sodium silicate or potassium silicate, or hydrolyzed and condensed from silane; precipitated or calcined alumina; precipitated or calcined titania; polymeric materials; and hybrids of metal oxides and polymeric materials.

11. The inhibitor composition used for chemical mechanical polishing as claimed in claim 9, wherein the abrasive particle is silica sol.

12. The inhibitor composition used for chemical mechanical polishing as claimed in claim 9, wherein the abrasive particle represents from 0.01 to 30% by weight of the total weight of the composition.

13. The inhibitor composition used for chemical mechanical polishing as claimed in claim 9, wherein the oxidant is hydrogen peroxide.

14. The inhibitor composition used for chemical mechanical polishing as claimed in claim 9, wherein the accelerator is selected from the group consisting of citric acid, oxalic acid, tartaric acid, histidine, alanine and glycine.

15. The inhibitor composition used for chemical mechanical polishing as claimed in claim 9, wherein the accelerator represents from 0.01 to 5% by weight of the total weight of the composition.

16. The inhibitor composition used for chemical mechanical polishing as claimed in claim 9, wherein the imidazoline compound or triazole compound or combinations thereof represent from 0.001 to 1% by weight of the total weight of the composition.

17. The inhibitor composition used for chemical mechanical polishing as claimed in claim 9, wherein the sarcosine and salt compounds thereof or combinations thereof represent from 0.001 to 1% by weight of the total weight of the composition.

18. The inhibitor composition used for chemical mechanical polishing as claimed in claim 9, wherein the solvent is water.
